(19) United States
(12) Patent Application Publication
(10) Pub. No.: US 2024/0272190 A1
(43) Pub. Date: Aug. 15, 2024

(54) LIQUID ASPIRATING OR DISPENSING METHOD AND APPARATUS

(71) Applicant: SPT LABTECH LTD., Hertfordshire (GB)

(72) Inventors: David Thierry GLEDHILL, Cambridgeshire (GB); Reuben Rodber PARDOE, Cambridgeshire (GB); Robert Steven LEWIS, Cambridgeshire (GB); David Gary COCHRANE, Bedfordshire (GB)

(21) Appl. No.: 18/567,484

(22) PCT Filed: Jun. 10, 2022
(86) PCT No.: PCT/GB2022/051471

§ 371 Date: Dec. 6, 2023

(30) Foreign Application Priority Data
Jun. 11, 2021 (GB) 2108405.8

(51) Int. Cl. G01N 35/10

(52) U.S. Cl. CPC G01N 35/1016; G01N 2035/103; G01N 2035/1044

(57) ABSTRACT

There is provided a liquid handling system for dispensing liquid, comprising a pipette tip and a plunger. The pipette tip has: a proximal end and a distal end and a longitudinal axis extending therebetween; an aperture at the distal end, a fluid cavity extending from the aperture at least partly towards the proximal end; an end portion disposed at the distal end, having an inner wall extending at an angle of at most 10 degrees relative to the longitudinal axis. The plunger is positioned inside the pipette tip, configured to extend between the proximal and distal ends of the pipette tip, and movable toward and away from the aperture. The system is configured to carry out at least two different operating methods for dispensing liquid.

### FIELD OF THE INVENTION

The present invention relates to a liquid dispense method, in particular to a method of dispensing liquid using a pipette tip having a plunger.

### BACKGROUND OF THE INVENTION

It is known to use a pipette to aspirate or dispense a liquid sample.

It is also known to use a pipette having a plunger disposed in a pipette tip. In a typical pipette known as a “positive displacement” pipette, this internal plunger contacts the sample liquid to be aspirated. The plunger is retracted away from an orifice to draw in sample liquid, and is driven towards the orifice to dispense sample liquid.

The inventor has identified several problems with known pipettes, which are particularly pertinent at low dispense volumes.

### SUMMARY OF THE INVENTION

A first aspect of the invention provides a method of aspirating and/or dispensing a sample liquid, comprising:
providing a liquid handling apparatus for aspirating and/or dispensing liquid, comprising:
a pipette tip, having:
   a proximal end and a distal end and a longitudinal axis extending therebetween;
   an aperture at the distal end,
   a fluid cavity extending from the aperture at least partly towards the proximal end;
   an end portion disposed at the distal end, having an inner wall extending at an angle of at most 10 degrees relative to the longitudinal axis;
a plunger positioned inside the pipette tip, configured to extend within the end portion between the proximal and distal ends of the pipette tip, and movable toward and away from the aperture;
retracting the plunger within the pipette tip so as to aspirate air to form a pre-sample air gap;
inserting the pipette tip into a sample liquid;
retracting the plunger within the pipette tip so as to aspirate sample liquid;
and withdrawing the pipette tip from the sample liquid.

The liquid handling apparatus may comprise a sealing portion configured to form a fluid-tight seal between the plunger and the pipette tip.

The pipette tip geometry specified in the first aspect of the invention, specifically the inner wall extending at an angle of at most 10 degrees, preferably 5 degrees, relative to the longitudinal axis, provides a significantly steeper angle than the shallow angle pipette tip of the known pipette referred to in the background section. This steep angle pipette tip has several significant advantages over known pipette tip geometries.

The inventors have identified that it enables the pipette tip to be used in an improved liquid aspirating method, with what will be referred to as a “pre-sample airgap”. In such a method, the plunger is initially retracted to draw in a gas, such as air, and then subsequently retracted to draw in a sample liquid. The advantage of using a pre-sample air gap method is that capillary filling of the tip is avoided, so the dead volume (sample liquid left in the pipette after dispensing) is reduced. The high angle tip ensures the liquid sample drawn in remains as a single slug that can be fully ejected on dispensing, as opposed to sticking to one side of the inner wall of the pipette tip. This allows very low volumes (<200 nl) to be handled.

The tip being configured for use with a pre-sample air gap has an additional advantage. Traditional positive displacement pipettes require a minimum volume of liquid to be aspirated to prime them correctly. Dispense performance can be compromised if they are not primed correctly. The pre-sample air gap described above removes the need for a priming volume, meaning low source-volumes (<500 nl) and low dispensing volumes (<200 nl) can be handled.

The method may further comprise retracting the plunger within the pipette tip so as to aspirate air to form a post-sample air gap. Specifically, this may involve continuing to withdraw the plunger after the sample has been aspirated, to draw in air or another gas. This has the following advantage. When performing non-contact dispensing, i.e. dispensing in which the sample liquid forms one or more droplets after leaving the pipette tip, before reaching a sample container or liquid in a sample container, a liquid sample must be travelling at a high enough velocity to detach from the pipette tip. In known pipette tips, it is difficult to achieve this velocity with small volumes, because the plunger stroke is relatively short. The post-sample airgap developed by the inventors provides a way to increase the plunger stroke by introducing a small airgap (or other gas) after the liquid sample is aspirated, i.e. using a post-sample airgap. The high angle tip of the first aspect ensures that this airgap can be introduced in a controlled manner. In known pipette tips, the inventors have identified that this mechanism is not viable in a pipette tip having a plunger. This is because the geometry of a known pipette tip, which has a much shallower pipette tip angle than the pipette of the first aspect, is such that the liquid would attach to one side of the inner wall surface of the pipette tip and/or plunger due to surface tension. This would lead to poor dispense performance in a post-sample airgap method. The steep angle of the pipette tip of the first aspect provides a more uniform liquid attachment, so mitigates this problem.

The method may further comprise: moving the plunger within the pipette tip so as to dispense the aspirated sample liquid such that the sample liquid detaches from the pipette tip without contacting a sample receptacle. This may involve detachment such that the sample liquid forms one or more droplets after leaving the pipette tip, before reaching a sample container or liquid in a sample container. As noted above, this may be referred to as a “non-contact” dispense method. This may also involve further moving the plunger to expel a pre-sample airgap.

The method may further comprise: moving the plunger within the pipette tip so as to dispense the aspirated sample liquid such that the sample liquid contacts a sample receptacle and/or or liquid, such as sample fluid, in a sample receptacle without detaching from the pipette tip. This may be referred to as a contact dispense method. This may also involve further moving the plunger to expel a pre-sample airgap.

Moving the plunger so as to dispense fluid, i.e. sample liquid or an airgap, may involve moving the plunger in an extension direction, which may be a downwards direction.

The receptacle may be a well or a series of wells, a plate such as an assay plate or microplate, a tray, a tube or series of tubes, any appropriate container, or liquid in a sample container.

The method may further comprise driving the pipette tip up and down as a preliminary step. This may be performed before any other aspirating and/or dispensing, or preparation step of the method.

A second aspect of the invention provides a computer program, which may be carried on a computer readable medium, the computer program comprising instructions that, when executed by a computer processor, cause the processor to carry out the following steps:
outputting a signal to cause retraction of a plunger within a pipette tip so as to aspirate air to form a pre-sample air gap;
outputting a signal to cause insertion of the pipette tip into a sample liquid;
outputting a signal to cause retraction of the plunger within the pipette tip so as to aspirate sample liquid; and
outputting a signal to cause withdrawal of the pipette tip from the sample liquid.

The computer program may also comprise instructions that, when executed by a processor, cause the processor to output signals for performing the method and any of its embodiments or variations as described herein. The processor may be comprised in, or operably connected to, a liquid handling system having any of the features described herein for carrying out the methods described.

A third aspect of the invention provides a liquid handling system for aspirating and/or dispensing liquid, comprising:
a pipette tip, having:
   a proximal end and a distal end and a longitudinal axis extending therebetween;
   an aperture at the distal end,
   a fluid cavity extending from the aperture at least partly towards the proximal end;
   an end portion disposed at the distal end, having an inner wall extending at an angle of at most 10 degrees relative to the longitudinal axis;
a plunger positioned inside the pipette tip, configured to extend between the proximal and distal ends of the pipette tip, and movable toward and away from the aperture;
wherein the system is configured to carry out at least two different operating methods for aspirating or dispensing liquid.

The instructions comprised in the computer readable medium, which is preferably non-transient, may be configured to cause the system to carry out at least two different operating methods for aspirating or dispensing liquid

Each of the operating method may be one of the following:
a contact dispense method, including creating no pre-sample, nor post-sample, air gap;
a non-contact dispense method, including creating no pre-sample, nor post-sample, air gap;
a non-contact dispense method, including creating no pre-sample air gap, but creating a post-sample air gap;
a contact dispense method including creating a pre-sample air gap;
a non-contact dispense method including creating a pre-sample air gap; and
a non-contact dispense method including creating a pre-sample and a post-sample air gap.

When the system is configured to carry out a particular method, it may be considered to have a corresponding mode of operation. The system may therefore be configured to have:
a no pre-sample nor post-sample air gap, contact dispense mode;
a no pre-sample nor post-sample air gap, non-contact dispense mode;
a no pre-sample air gap, post-sample air gap, non-contact dispense mode;
a pre-sample air gap, contact dispense mode;
a pre-sample air gap, non-contact dispense mode
a pre-sample and post-sample air gap, non-contact dispense mode; and
a pre-sample and post-sample air gap, contact dispense mode.

The system may be configured to operate in at least two different operating modes for aspirating or dispensing liquid.

The at least two operating methods or modes may comprise at least one pre-sample airgap method or mode, and at least one method or mode with no pre-sample air gap.

The two operating methods or modes may comprise at least one non-contact dispense method or mode and at least one contact dispense method or mode.

The two operating methods or modes may comprise at least one post-sample air gap method or mode, and at least one no post-sample air gap method or mode.

The system may comprise an actuator configured to move the plunger relative to the pipette tip, to carry out the at least two operating methods or modes.

The system may comprise a computer readable medium comprising instructions that, when executed by a processor, cause the processor to carry out the following steps:
outputting a signal to cause retraction of the plunger within the pipette tip so as to aspirate air to form a pre-sample air gap;
outputting a signal to cause insertion of the pipette tip into a sample liquid;
outputting a signal to cause retraction of the plunger within the pipette tip so as to aspirate sample liquid; and
outputting a signal to cause withdrawal of the pipette tip from the sample liquid.

The computer readable medium may comprise instructions that, when executed by a processor, cause the processor to signal to an actuator to cause any of the aspirating and/or dispensing method steps noted herein.

The pipette tip end portion inner wall extending at an angle of at most 10 degrees relative to the longitudinal axis may extend as such for at least 5 mm from the distal end.

The end portion may have an outer wall extending at an angle of at most 10 degrees relative to the longitudinal axis, preferably for at least 5 mm.

A fourth aspect of the invention provides a liquid handling apparatus for aspirating and/or dispensing liquid, comprising
a pipette tip, having:
   a proximal end and a distal end and a longitudinal axis extending therebetween;
   an aperture at the distal end,
   a fluid cavity extending from the aperture at least partly towards the proximal end;
   an end portion disposed at the distal end, having an inner wall extending at an angle of at most 10 degrees relative to the longitudinal axis;
a plunger positioned inside the pipette tip, configured to extend within the end portion between the proximal and distal ends of the pipette tip, and movable toward and away from the aperture;
a sealing portion configured to form a fluid-tight seal between the plunger and the pipette tip;
configured to carry out the steps of:
   retracting the plunger within the pipette tip so as to aspirate air to form a pre-sample air gap;
   inserting the pipette tip into a sample liquid;
   retracting the plunger within the pipette tip so as to aspirate sample liquid; and
   withdrawing the pipette tip from the sample liquid.

### BRIEF DESCRIPTION OF THE DRAWINGS

Embodiments of the invention will now be described with reference to the accompanying drawings, in which:

FIG. 1 is a cross section through a pipette tip and a side view of a plunger;

FIG. 2 is a perspective view of a pipette tip and plunger in a disassembled state;

FIG. 3 is an enlarged view of the end portion of the pipette tip and an end portion of the plunger in an assembled state; and

FIGS. 4(a) to 4(e) illustrate a no pre-sample air gap, post-sample air gap, non-contact dispense method;

FIGS. 5(a) to 5(e) illustrate a contact dispense method including creating a pre-sample air gap;

FIGS. 6(a) to 6(e) illustrate a non-contact dispense method including creating a pre-sample air gap;

FIGS. 7(a) to 7(e) illustrate a non-contact dispense method including creating a pre-sample and a post-sample air gap;

FIG. 8 is a schematic of a liquid dispensing apparatus; and

FIG. 9 is a view of part of a pipette tip.

### DETAILED DESCRIPTION OF EMBODIMENT(S)

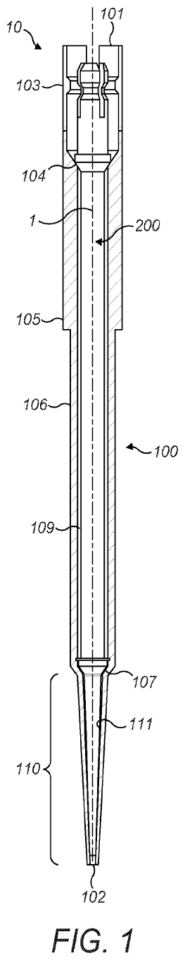

FIG. 1 shows a pipette 10 for aspirating and/or dispensing liquids. The pipette 10 comprises a pipette tip 100 and a plunger 200.

The pipette tip 100 may be a receptacle for receiving and/or containing a sample fluid, or a sample liquid. The pipette tip 100 may be configured for insertion into a container of sample liquid, or into sample liquid.

The pipette tip 100 has a proximal end 101 and a distal end 102 defining a longitudinal axis 1 extending therebetween.

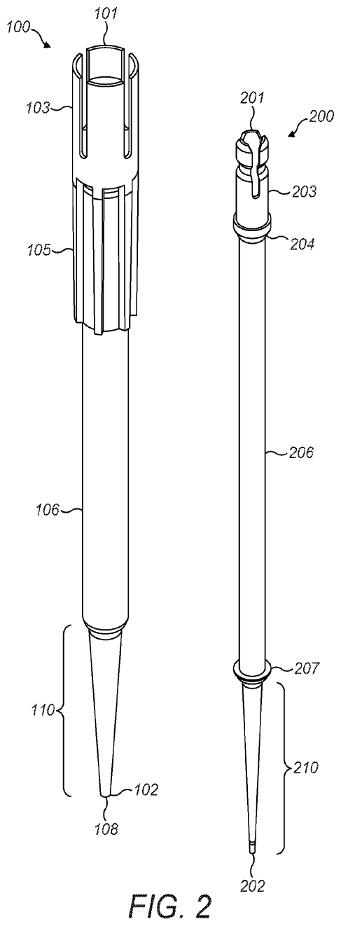

The pipette tip 100 has an aperture 108 at its distal end 102, as indicated in FIG. 2. The aperture 108 may be defined by an inner wall surface 111 of the pipette tip 100 at the distal end 102, specifically at an outermost distal point of the pipette tip 100. The aperture 108 may define a substantially circular shape or circle. The aperture 108 may have a diameter of at most 1 mm, preferably at most 0.5 mm, further preferably at most 0.4 mm. Optionally, the aperture 108 may have a diameter of at most 0.35 mm, 0.3 mm, 0.25 mm, 0.1 mm. Optionally, the aperture 108 may have a diameter of at least 0.4 mm.

The inner wall 111 of the pipette tip 100 may extend through a support portion 105 and/or a main body portion 106 of the pipette tip 100. The inner wall surface 111 may be substantially tubular and/or have parallel sides within the support portion 105 and/or main body portion 106. The pipette tip 100 has a fluid cavity 109 extending from the aperture 108 at least partially towards the proximal end 101. The fluid cavity 109 may be configured to receive and/or retain a fluid, such as an airgap or sample liquid. The fluid cavity 109 may be substantially elongate. The fluid cavity may be defined by the inner wall surface 111 of the pipette tip 100. The fluid cavity 109 may be mostly or wholly disposed within an end portion 110 of the pipette tip 100.

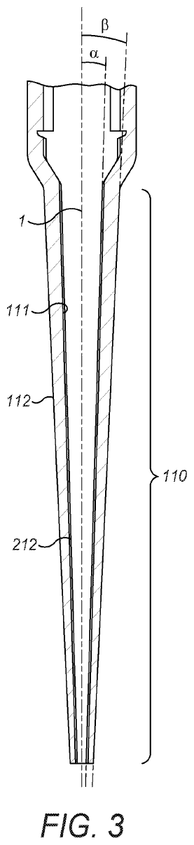

The pipette tip 100 comprises an end portion 110 disposed at the distal end 102, having an inner wall surface 111 extending at an angle α of at most 10 degrees, or π/18 radians, or approximately 0.17 to 0.18 radians, relative to the longitudinal axis 1, optionally for at least 5 mm. Preferably, the inner wall surface 111 extends at an angle α of at most 5 degrees, or π/36 radians, or approximately 0.08 to 0.09 radians, relative to the longitudinal axis 1, for at least 5 mm. The inner wall surface 111 may extend at an angle α of at most 4 degrees relative to the longitudinal axis 1; preferably at most 3 degrees relative to the longitudinal axis 1; further preferably at most 2 degrees relative to the longitudinal axis 1. The angle α may be seen in FIG. 3. The angle α may be at least 0 degrees, i.e. parallel to the longitudinal axis 1. A pipette tip end portion 110 extending at an angle of at least 2 degrees or at least 1 degree relative to the longitudinal axis 1 may be advantageous compared to an angle of 0 degrees as it may be easier, simpler and/or cheaper to manufacture. The angle α may be measured using any appropriate angle measurement technique known to the skilled person.

The longitudinal axis 1 may be a central axis about which the pipette tip 101 and/or plunger 200 is disposed. The longitudinal axis 1 may define a central axis about which the pipette tip 100 and/or plunger 200 are disposed uniformly or symmetrically. The pipette tip 100 and/or plunger 200 may be configured so that the direction of aspirating and/or dispensing is along the longitudinal axis 1.

The inner wall surface 111 of the end portion 110 may extend for at least 5 mm, preferably 7 mm at an angle of at most or equal to angle α, preferably at least 10 mm at an angle of at most or equal to angle α, further preferably at least 12 mm at an angle of at most or equal to angle α. The inner wall 111 of the end portion 110 of the pipette tip 100 may define a straight-sided shape, such as a frusto-conical or cylindrical shape.

The end portion 110 may have an outer wall surface 112 extending at an angle β, as best seen in FIG. 3, of at most 10 degrees, preferably at most 5 degrees, relative to the longitudinal axis 1, optionally for at least 5 mm. The outer wall surface 112 of the end portion of the pipette tip may define a straight-sided shape, such as a frusto-conical or cylindrical shape. The end portion 110 may have a maximum outer diameter of at most 4 mm, preferably at most 3 mm, further preferably at most 2 mm, further preferably at most 1 mm, further preferably at most 0.7 mm, further preferably at most 0.65 mm. Optionally, the end portion 110 may have a maximum outer diameter of at least 0.5 mm, optionally at least 0.6 mm, optionally at least 0.65 mm.

The pipette tip 100 may be substantially elongate, extending between its proximal and distal ends, 101, 102. The pipette tip 100 may be substantially or wholly hollow. The pipette tip 100 may comprise or consist of a polymeric material. The pipette tip 100 may comprise or consist of a homogeneous material. The pipette tip 100 may comprise or consist of a translucent or transparent material.

The pipette tip 100 may comprise a series of portions, each having a different function, distinguishing features and/or a different shape or dimension. The pipette tip 100 may comprise one or more of: a tip connector portion 103, a centering portion 104, a support portion 105, a main body portion 106, and a bridging portion 107, for example as shown in FIG. 1. From the proximal end 101 to the distal end 102, each portion may be arranged in the order: tip connector portion 103, centering portion 104, support portion 105, main body portion 106, a bridging portion 107, and end portion 110. The fluid cavity 109 may extend through one, more or all of the portions of the pipette tip 100. The plunger 200 may extend through one, more or all of the portions of the pipette tip 100.

The tip connector portion 103 may be configured for connection to a liquid handling system. The tip connector portion 103 may be configured as a snap-fit connection.

The centering portion 104 may be configured to centre the plunger 200 within the pipette tip 100. The centering portion 104 may have an inner surface and may define a tapered or conical shape with its inner surface.

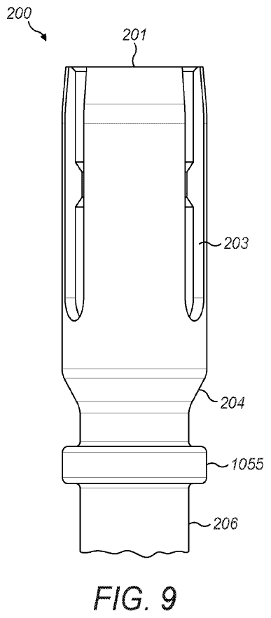

The support portion 105 may comprise one or more ribs, configured to reduce flexibility and/or improve structural integrity of the pipette tip 100. The one or more ribs may extend on an outer surface of the pipette tip, between the proximal end 101 and distal end 102, for example as best seen in FIG. 2. Alternatively and/or in addition to one or more ribs, the support portion 105 may comprise a ring 1055, for example as shown in FIG. 9. The ring 1055 may be configured to provide a reaction force during use. The ring 1055 may be configured to position or centre the pipette tip 100 during storage and/or use. The ring 1055 may be configured to at least partly facilitate ejection of the pipette tip 100 from a moulding tool during manufacture.

The main body portion 106 may be substantially cylindrical and/or elongate. The main body portion 106 may have a substantially uniform inner diameter and/or outer diameter. The main body portion 106 may extend along at least half of the length of the pipette tip 100. The main body portion 106 may have a larger inner and/or outer diameter than any diameter of the end portion 110.

The bridging portion 107 may be configured to bridge the main body portion 106 to the end portion 110. The bridging portion 107 may define a step between the main body portion 106 and the end portion 110. The bridging portion 107 may be substantially tapered, conical and/or dome-shaped.

The plunger 200 is positioned inside the pipette tip 100. The plunger 200 may be configured to move relative to the pipette tip 100 so as to draw in a fluid into the pipette tip 100, and/or to expel a fluid from the pipette tip 100. Specifically, when moving from an extended position to a retracted position, the plunger 200 may draw fluid, such as an airgap or sample liquid, into the pipette tip 100. When moving from a retracted position to an extended position, the plunger 200 may expel fluid, such as an airgap or sample liquid, from the pipette tip 100.

The plunger 200 and/or pipette tip 100 may be configured so that in an extended position, the plunger 200 may be wholly contained within the pipette tip 100. The plunger 200 is configured to extend at least partly between the proximal and distal ends 101, 102 of the pipette tip 100 into the end portion 110. The plunger 200 may be configured to extend substantially or wholly between the proximal and distal ends 101, 102 of the pipette tip 100 into the end portion 110. The plunger 200 is movable towards and away from the aperture 109 to aspirate or dispense fluid from the pipette tip 100. The plunger 200 may have an end portion outer wall surface 212 configured for alignment with the inner wall surface 111 of the pipette tip end portion 110. The plunger 200 may comprise or consist of a polymeric material. The plunger 200 may comprise or consist of a homogeneous material.

The plunger 200 may comprise a series of portions, each having a different function, distinguishing features and/or a different shape or dimensions. The plunger 200 may comprise one or more of: a plunger connector portion 203, a centering portion 204, a main body portion 206, and a sealing portion 207, for example as shown in FIG. 1. From the proximal end 201 to the distal end 202, each portion may be arranged in the order: plunger connector portion 203, centering portion 204, main body portion 206, sealing portion 207 and end portion 210.

The plunger connector portion 203 of the plunger 200 may be configured to be received in the tip connector portion 103 of the pipette tip 100. The plunger connector portion 203 may be configured for connection to a liquid handling system. The plunger connector portion 203 may be configured as a snap-fit connection.

The centering portion 204 may be configured to be received in a centering portion 104 of the pipette tip 100, so as to centre the plunger 200 within the pipette tip 100. The centering portion 204 may be substantially conical or dome-shaped.

The main body portion 206 of the plunger 200 may be configured to be received in the main body portion 106 of the pipette tip 100. The main body portion 206 may be substantially cylindrical and/or elongate. The main body portion 206 may have a substantially uniform diameter. The main body portion 206 may extend along at least half of the length of the plunger, optionally at least two thirds of the length of the plunger 200. The main body portion 206 may have a larger diameter than the diameter of the end portion 210.

The sealing portion 207 of the plunger 200 may be configured to be received in the bridging portion 107 of the pipette tip 100. The sealing portion 207 may be configured to form a seal against an inner wall of the pipette tip 100. The sealing portion 207 may form a fluid-tight seal within the pipette tip, such that fluid cannot pass from a proximal side of the sealing portion 207 to a distal side of the sealing portion 207 when the plunger 200 is installed in the pipette tip 100. The sealing portion 207 may be at least partly flexible. The sealing portion 207 may be configured to bridge the main body portion 206 to the end portion 210. The sealing portion 207 may define a step between the main body portion 206 and the end portion 210. The sealing portion 207 may be substantially tapered, conical and/or dome-shaped.

The end portion 210 of the plunger 200 may be configured to be received in the end portion 110 of the pipette tip 100. The end portion 210 may have a smaller diameter than the sealing portion 207 and/or the main body portion 206.

The end portion 210 may substantially or entirely fill the end portion 110 of the pipette tip 100. This may be such that there is no airgap within the pipette tip end portion 110 when the plunger end portion 210 is in an extended position. The end portion 210 may contact the inner wall surface 111 of the pipette tip end portion 110 when the plunger end portion 210 is in an extended position.

The end portion 210 maybe substantially elongate and/or conical. The end portion 210 may have substantially straight walls. The end portion 210 may have an outer wall 212 having a shape that complements, matches and/or corresponds to a shape of the inner wall surface 111 of the pipette tip end portion 110. The end portion 210 may have an outer wall 212 that is aligned with and/or parallel to the inner wall surface 111 of the pipette tip end portion 110, over at least part of the length of the inner wall surface 111, substantially all of, or the entire length of the inner wall surface 111.

The end portion 210 of the plunger 200 may have a substantially flat face at its distal end 202. The end portion 210 of the plunger 200 may seal the aperture 108 of the pipette tip end portion 110 when the plunger 200 is in an extended position. Specifically, the distal end 202 of the plunger 200 may seal the aperture 108 of the pipette tip end portion 110. The end portion 210 may be configured such that the plunger distal end 202 is disposed at the pipette tip distal end 102 when the plunger 200 is in an extended position. The plunger 200 may be configured such that the plunger distal end 202 does not extend beyond the pipette tip distal end 102 when in an extended position.

The pipette 10 having any of the variations noted herein may be comprised in a liquid handling system (not shown), the liquid handling system also comprising an actuator configured to move the plunger 200 relative to the pipette tip 100.

The pipette tip 100 and/or plunger 200 may be detachable and/or attachable to or from a pipetting system or apparatus. The pipette tip 100 may be detachable and/or attachable at its proximal end 101. The plunger 200 may be detachable and/or attachable at its proximal end 201. The pipette tip 100 and/or plunger may comprise a connector means or portion 103, 203, which may be disposed at the respective proximal end 101, 201, to make the pipette tip 100 or plunger 200 suitable or configured for attachment or detachment from a pipetting system or apparatus. The pipette tip 100 and/or plunger 200 may be configured so that during aspiration, sample liquid does not extend past the proximal end 101, so does not pass into a liquid handling system or apparatus. In this way, sample liquid may be contained within the removable pipette tip 100, preventing contamination of a liquid handling system or apparatus. This in turn makes the apparatus or system suitable for use with multiple different sample fluids, through use of removable and optionally disposable pipette tips 100 and/or plungers 200.

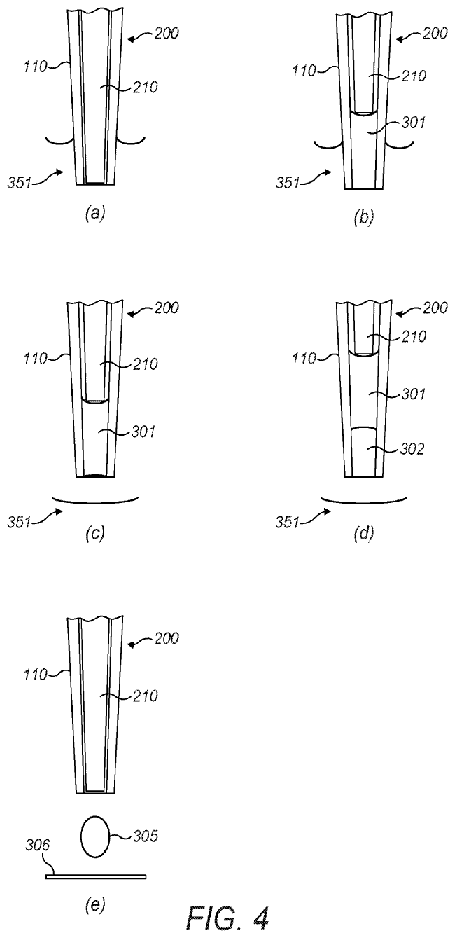

The apparatus of FIGS. 1 to 3 may be used in a method of aspirating and/or dispensing of FIGS. 4 to 7. As the skilled person will appreciate from the description of FIGS. 1 to 3, the apparatus provided is configured to aspirate and/or dispense fluid, and/or to retain fluid between aspirating and dispensing. The apparatus is provided to carry out one or more steps of the method, which may be controlled by manual operation, or partially or fully automated. The apparatus provided in the method may have one, more or all features described herein. Specifically, the liquid handling apparatus may comprise one or more features as described previously, for example as described in relation to FIGS. 1 to 3.

The apparatus comprises a pipette tip 100 having: a proximal end 101 and a distal end 102 defining a longitudinal axis 11 therebetween. The pipette tip 100 also has an aperture 108 at the distal end 102, a fluid cavity 109 extending from the aperture 108 at least partly towards the proximal end 101. The aperture 108 permits fluid into and out of the pipette tip 100, and the fluid cavity 109 of the apparatus is configured to retain fluid (i.e. liquid or gas), such as a sample liquid, and/or an airgap.

The pipette tip 100 also has an end portion 110 disposed at the distal end 102, having an inner wall 111 extending at an angle of at most 10 degrees relative to the longitudinal axis 11. This can be particularly advantageous when used in a method involving a pre-sample or post-sample airgap.

The apparatus also comprises a plunger 200 positioned inside the pipette tip 100, configured to extend within the end portion between the proximal 101 and distal ends 102 of the pipette tip 100, and movable toward and away from the aperture 108. The plunger is configured to draw fluid into the fluid cavity and/or to expel fluid from the fluid cavity, by causing pressure changes within the pipette tip 100.

The method comprises retracting the plunger 200 within the pipette tip 100 so as to aspirate air to form a pre-sample air gap, as noted above, by causing a drop in pressure within the pipette tip 100, such that atmospheric air or other gas may pass into the pipette tip 100 to equalise this pressure. This air or gas disposed within the pipette tip, between the aperture 108 and plunger 200 is referred to as a pre-sample air gap, as it precedes the sample in order of aspiration into the pipette tip 100.

The pipette tip 100 is then inserted into a sample liquid 351, with the pre-sample airgap 300 maintained within the pipette tip 100. In this position, the pre-sample airgap 300 remains within the pipette tip 100, and sample liquid 351 may remain wholly outside the pipette tip. The sample liquid 351 is likely to displace around the pipette tip 100, while being prevented from entering the pipette tip 100 by pressure within the pipette tip 100 from the pre-sample airgap 300. The step of inserting the pipette tip 100 into a sample liquid 351 may involve moving the pipette tip 100 downwards relative to a fixed receptacle such as a well or a series of wells, a plate such as an assay plate or microplate, a tray, any appropriate container, or liquid in a sample container, and/or moving a sample liquid container upwards relative to a fixed pipette tip 100, and/or moving both a sample liquid container and the pipette tip 100 towards one another.

While still in the sample liquid 351, the plunger 200 is retracted within the pipette tip 100 so as to aspirate sample liquid 301. In doing this, the pipette tip 100 fills at least partly with sample liquid 301, which is disposed and retained below the pre-sample airgap 300 within the pipette tip 100. In such a configuration, disposed directly below the plunger 200 is the pre-sample airgap 300, below which the sample liquid 301 is retained as a slug of liquid, which is disposed between the pre-sample airgap 300 and the aperture 108. The step of retracting the plunger 200 within the pipette tip 100 so as to aspirate air to form a pre-sample air gap 300 may involve retracting the plunger 200 relative to the pipette tip 100 by at most 20 mm, optionally by at most 10 mm, optionally by at most 5 mm, optionally at most 1 mm. The pre-sample air gap 300 may have a volume of approximately 30 μl, optionally at most 20 μl, optionally at most 10 μl, optionally at most 5 μl, optionally at most 3 μl. Functionally speaking, the purpose of the pre-sample air-gap is to create enough space so that the aspirate sample does not wick internally to the pipette tip and reach the plunger. In practice, this distance, or volume of pre-sample air gap will vary depending upon the fluid to be aspirated. Any gap sufficient to prevent wicking of the sample liquid 301 onto the plunger can be beneficial. The sample 301 of fluid is preferably maintained low down in the tapered section of the pipette tip to maintain its integrity during the ejection sequence.

The pipette tip 100 is then withdrawn from the sample liquid 351, with the pre-sample airgap 300 and sample liquid 301 held in the pipette tip 100. This may involve moving the pipette tip 100 upwards relative to a fixed receptacle, and/or moving a receptacle downwards relative to a fixed pipette tip 100, and/or moving both a receptacle and the pipette tip 100 apart from one another.

The method may comprise also providing sample liquid 351, before, during or after providing the apparatus, which may be provided in a receptacle such as a well or a series of wells, assay plate, tray, microplate or any appropriate container. The receptacle may be provided below or inserted into the apparatus, at a location such that the pipette tip 100 or a series of pipette tips can be lowered into or proximate the receptacle. The apparatus may comprise a body with a microplate receiving area, or deck, and a pipetting head positioned above the microplate receiving area. The microplate receiving area may have a substantially horizontal upper surface arranged to receive a laboratory microplate. The receiving area can be located on a height-adjustable support structure which enables the height of the microplate receiving area to be varied as required. The receiving area may be configured to retain a laboratory microplate in a fixed position. For example, the upper surface of the receiving area may comprise one or more recesses arranged to receive a microplate and to prevent lateral translation of the microplate with respect to the receiving area. The pipetting head of the apparatus may be configured to hold an array of pipettes, and may be moveable in relation to a deck to bring pipettes mounted on the pipetting head into close proximity to a microplate supported on the deck to allow liquid to be aspirated from or dispensed into the wells of the microplate.

As a skilled person will appreciate, each step may be performed one after the other, optionally in the order listed. Equally, one or more steps may be performed at least partly simultaneously. For example, the step of retracting the plunger 200 within the pipette tip 100 so as to aspirate sample liquid 351 may be performed simultaneously with inserting the pipette tip 100 into a sample liquid 351 and/or withdrawing the pipette tip 100 from the sample liquid 351.

FIGS. 4 to 7 illustrate methods of aspirating and/or dispensing a sample liquid 301, comprising providing a liquid handling apparatus for aspirating and/or dispensing liquid, comprising a pipette tip 100, and a plunger 200 positioned inside the pipette tip 100.

FIGS. 4 to 7 show particularly advantageous combinations of steps. As a skilled person will appreciate, these are not the only combinations available to the skilled person when implementing the method of aspirating and/or dispensing sample liquid 351. Specifically, the skilled person may carry out one or more steps of each method with additional steps before, after, or between various method steps.

The method of FIG. 4 comprises the steps:
4a) Inserting the pipette tip 100 into a sample liquid 351;
4b) Retracting the plunger 200 within the pipette tip 100 so as to aspirate sample liquid 351;
4c) Withdrawing the pipette tip 100 from the sample liquid;
4d) Retracting the plunger 200 within the pipette tip so as to aspirate air to form a post-sample air gap 302; and
4e) Moving the plunger 200 within the pipette tip 100 so as to dispense the aspirated sample liquid 301 such that the sample liquid 301 detaches from the pipette tip 100 without contacting a sample receptacle or liquid held therein 306.

A post-sample airgap 302, such as the post-sample airgap of step 4b, is caused by a drop in pressure within the pipette tip 100, caused by drawing the plunger 200 away from the aperture 108, which draws the sample liquid 301 away from the aperture 108 further within the pipette tip 100, such that atmospheric air or other gas is drawn into the pipette tip 100 through the aperture 108 to equalise this pressure. This air or gas disposed within the pipette tip 100, between the aperture 108 and the sample liquid 301 is referred to as a post-sample air gap 302, as it follows the sample in order of aspiration into the pipette tip 100. The plunger may be moved before step 4e to dispense the post-sample airgap.

Retracting the plunger 200 within the pipette tip 100 so as to aspirate air to form a post-sample air gap 302 may involve retracting the plunger 200 relative to the pipette tip 100 so that the sample liquid 301 can be accelerated during dispensing, such that sample liquid 301 has sufficient energy to detach cleanly from the pipette tip 100 upon exiting the aperture 108. This may involve retracting the plunger 200 relative to the pipette tip 100 by an amount more than zero and up to 0.5 mm, optionally up to 0.3 mm, optionally up to 0.03 mm. The post-sample air gap 302 may have a volume of approximately at most 1 μl, and/or approximately at least 0.1 pl. The post-sample air gap must be sufficiently small so that the sample liquid 301 does move beyond the tapered end portion 110 of the pipette tip 100 and remains in the tapered end portion during the aspiration and dispensing procedure.

As a skilled person will appreciate, in a non-contact dispensing step, such as step 4e, a droplet may form when the sample liquid 301 leaves the pipette tip, which is not limited to a specific shape or configuration. In step 4e the liquid sample must reach a state where it does not contact the pipette tip 100 before it reaches a receptacle. This may involve the sample liquid 301 being wholly surrounded by air, and as such may form a shape minimising surface tension, which may be at least partly spherical.

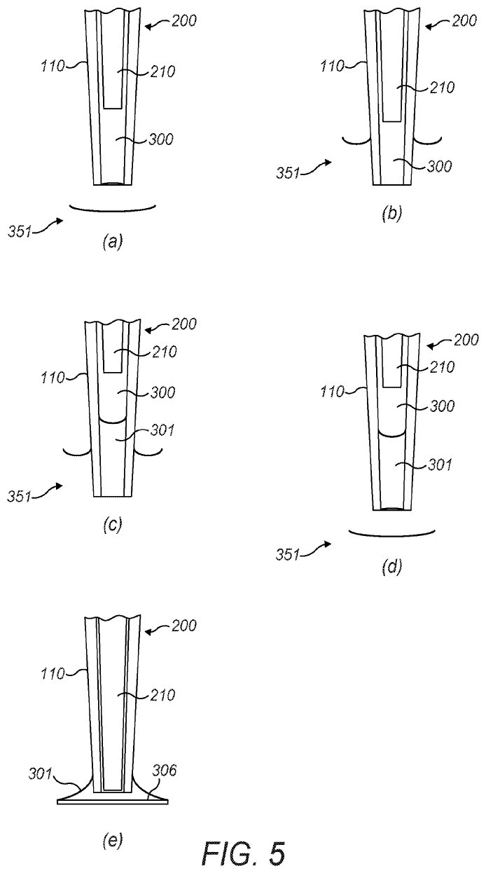

The method of FIG. 5 comprises the steps of:
5a) Retracting the plunger 200 within the pipette tip 100 so as to aspirate air to form a pre-sample air gap 300;
5b) Inserting the pipette tip 100 into a sample liquid 351;
5c) Retracting the plunger 200 within the pipette tip 100 so as to aspirate sample liquid 301;
5d) Withdrawing the pipette tip 100 from the sample liquid 351; and
5e) Moving the plunger 200 within the pipette tip 100 so as to dispense the aspirated sample liquid 301 such that the sample liquid 301 contacts a sample receptacle 306 without detaching from the pipette tip.

In a contact dispense method, such as the step of 5e, the liquid sample 301 contacts the pipette tip 100 and receptacle 306 simultaneously, for example as shown in FIG. 5e. In such a situation, surface tension from the receptacle 306 may distort the shape of the sample liquid 301 before it detaches from the pipette tip 100.

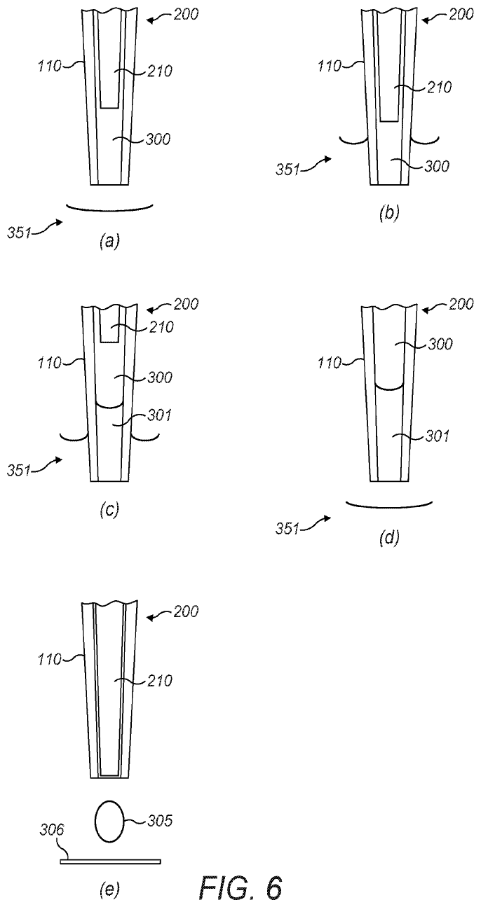

The method of FIG. 6 comprises the steps of:
6a) Retracting the plunger 200 within the pipette tip 100 so as to aspirate air to form a pre-sample air gap 300;
6b) Inserting the pipette tip 100 into a sample liquid 351;
6c) Retracting the plunger 200 within the pipette tip 100 so as to aspirate sample liquid 301;
6d) Withdrawing the pipette tip 100 from the sample liquid 351;
6e) Moving the plunger 200 within the pipette tip 100 so as to dispense the aspirated sample liquid 301 such that the sample liquid 301 detaches from the pipette tip 100 without contacting a sample receptacle 306. This may cause the sample liquid to form one or more droplets 305 after leaving the pipette tip, before reaching a sample container.

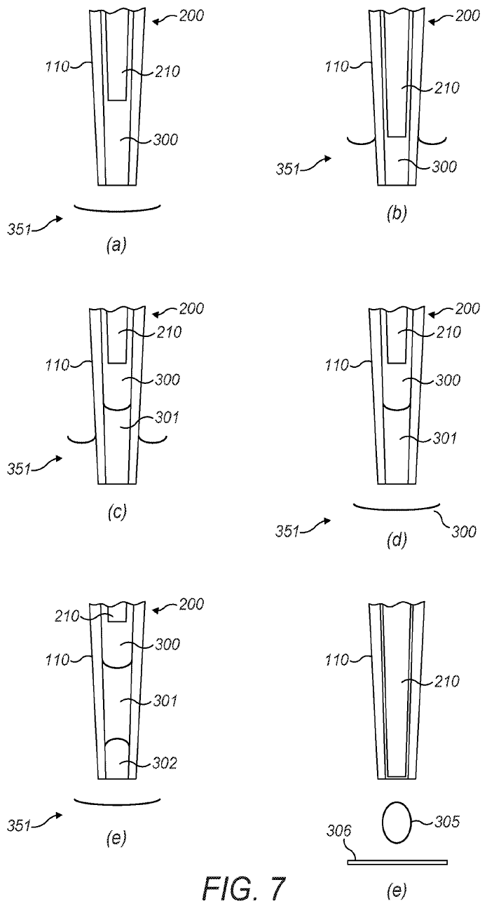

The method of FIG. 7 comprises the steps:
7a) Retracting the plunger 200 within the pipette tip 100 so as to aspirate air to form a pre-sample air gap 300;
7b) Inserting the pipette tip 100 into a sample liquid 351;
7c) Retracting the plunger 200 within the pipette tip 100 so as to aspirate sample liquid 301;
7d) Withdrawing the pipette tip 100 from the sample liquid 301;
7e) Retracting the plunger 200 within the pipette tip 100 so as to aspirate air to form a post-sample air gap 302; and
7f) Moving the plunger 200 within the pipette tip 100 so as to dispense the aspirated sample liquid 301 such that the sample liquid 301 detaches from the pipette tip 100 without contacting a sample receptacle 306. Before step 7f, the plunger may be moved to dispense the post-sample airgap.

Methods comprising retracting the plunger 200 within the pipette tip 100 so as to aspirate air to form a pre-sample air gap 300 may be referred to as a pre-sample air gap method or pre-sample air gap operating mode. FIGS. 5, 6 and 7 demonstrate this step. Methods which do not involve this step, such as the method of FIG. 4, may be referred to as a no pre-sample air gap method or no pre-sample air gap operating mode.

Methods comprising retracting the plunger 200 within the pipette tip 100 so as to aspirate air to form a post-sample air gap 302, such as the methods of FIGS. 4 and 7, may be referred to as a post-sample air gap method or post-sample air gap operating mode. Methods which do not involve this step, such as the methods of FIGS. 5 and 6, may be referred to as a no post-sample air gap method or no post-sample air gap operating mode.

Methods comprising moving the plunger 200 within the pipette tip 100 so as to dispense the aspirated sample liquid 301 such that the sample liquid 301 contacts a sample receptacle 306 without detaching from the pipette tip 100, such as the method of FIG. 5, may be referred to as a contact dispense method or contact operating mode.

Methods comprising moving the plunger 200 within the pipette tip 100 so as to dispense the aspirated sample liquid 301 such that the sample liquid 301 detaches from the pipette tip 100 without contacting a sample receptacle 306, such as the methods of FIGS. 4, 6 and 7, may be referred to as a non-contact dispense method or non-contact operating mode.

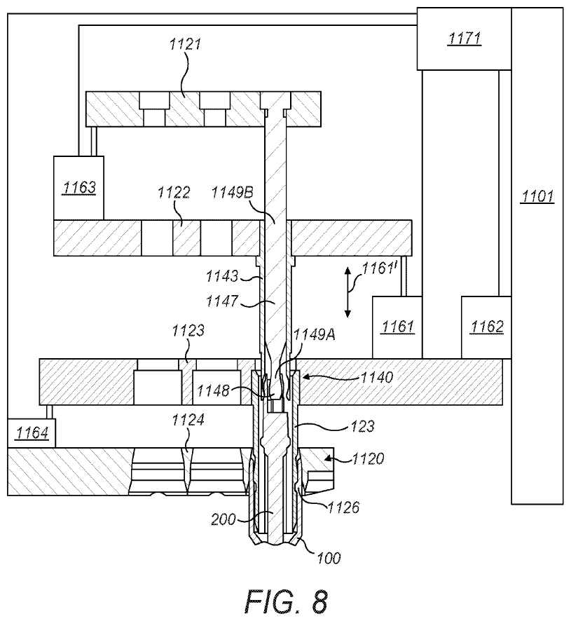

The FIG. 8 embodiment shows a particular embodiment in which the pipette tip 100 and plunger 200 are attached to the apparatus via a plurality of plates 1121, 1122, 1123, 1124. The skilled person will appreciate that the apparatus and method of the present disclosure may alternatively involve other attachment components and mechanisms. The apparatus may comprise a first plate 1121, a second plate 1122, a third plate 1123 and/or a fourth plate 1124. The plunger 200 may be attached to the first and second plates 1121, 1122, which may be referred to as plunger plates. The pipette tip 100 may be attached to the third and fourth plates 1123, 1124, which may be referred to as pipette plates. The pipette tip 100 may be attached to the apparatus, specifically to the third and fourth plates 1123, 1124, by a pipette tip clamping mechanism 1120, which may involve a clamp at the pipette tip connector portion 103. The plunger 200 may be attached to the apparatus, specifically to the first and second plates 1121, 1122 by a plunger clamping mechanism 1140, which may involve a clamp at the plunger tip connector portion 203. One or more plates may comprise multiple clamping mechanisms 1120, 1140, to clamp multiple pipette tips 100 and plungers 200.

As regards the plunger clamping mechanism 1140, there may be provided an array of plunger clamping members 1147 each associated with one of a plurality of plunger mounts 1143. The array of plunger clamping members 1147 may be provided in the form of a plurality of clamping rods 1147 which extend axially from a first plate 1121 and extend into the bores defined within the plunger mount sleeves 1143. Each clamping rod 1147 may have an enlarged head 1148 at its lower end which extends from a narrower neck region 1149A. The enlarged head 1148 has an outer diameter which is less than the inner diameter of the plunger mount sleeve 1143. In this manner, a small clearance is provided between the outer surface of the enlarged head 1148 and the inner surface of the plunger mount sleeve 1143 when the plunger clamping mechanism is engaged. The neck 1149A has an outer diameter which is less than that of the enlarged head 1148. Preferably, each clamping rod 1147 also has a main shaft 1149B with an outer diameter which is substantially the same as the inner diameter of the region of the plunger mount sleeve 1143 in which it is located. The main shaft 1149B slides along the inner surface of the plunger mount 1143 as the first plate 1121 is moved up and down in the axial direction relative to the second plate 1122. This can help to ensure correct lateral alignment between the plunger mounts 1143 and the plunger clamping members 1147.

As regards the pipette tip clamping mechanism 1120, the tip connector portion 103 is configured for connection to a liquid handling system, for example with a snap-fit connection. The tip connector portion 103 may comprise a split tubular wall which may be defined by a plurality of flexible segments. The flexible segments may be configured to resiliently deflect in a radially outward direction to increase the outer diameter of the proximal end 101 of the pipette tip 100 from a first outer diameter, in which the flexible segments are undeflected and the tip connector portion is in a rest state, to a second outer diameter, in which the flexible segments are deflected radially outwardly and the tip connector portion is in an expanded state. In the embodiment depicted, the tip connector portion 103 comprises a plurality of axially extending discontinuities or slots in the tubular wall which separate a plurality of flexible segments. The plurality of slots may be 2, 3 or 4 slots, and the plurality of flexible segments may be 2, 3 or 4 segments. The tip connector portion 103 may comprise any suitable number of axially extending discontinuities to define any number of flexible segments. The arrangement of flexible segments and slots enables the tip connector portion to expand without requiring significant forces to be exerted on the tip connector portion. The tip connector portion 103 may further comprise one or more radially extending features 1126 on its inner surface by which the pipette tip may be coupled to the pipetting head. The radially extending feature on the inner surface of the tip connector portion 103 may comprise a protrusion, which extends radially inward, and/or a recess or groove, which extends radially outward. The radially extending feature may extend in a circumferential direction. In the depicted embodiment, the radially extending feature on the inner surface of the tip connector portion 103 comprises a part-annular rib 1126 which protrudes from the inner surface of the tip connector portion 103. Preferably, the second outer diameter to which the tip connector portion is increased is larger than the first outer diameter by at least the radial extent of the radially extending feature 1126.

The pipette tip 100 may be clamped between a tip mount sleeve 123 and a plate, such as the fourth plate 1124 as shown in FIG. 8. The tip mount sleeve 123 may be provided on a plate, such as the third plate 1123.

With reference to FIG. 8, one or more method steps may be carried out by one or more actuators 1161, 1162, 1163, which may be comprised in the liquid dispensing apparatus. The one or more actuators may be controlled by one or more controllers 1171.

The controller 1171 may comprise one or more of: a processor, a memory, one or more input ports, one or more output ports, and a user input device.

The user input device may comprise a mouse or keyboard, a hand-held device or touchscreen, which may have a graphical user interface. There may be provided a display such as a graphical user interface, which may be configured to display outputs. The display may be configured for input of information, and present an option to select a method or mode of operation, and/or an option to activate the mode. The display may display information such as what mode the apparatus is operating in, and/or any variable or variables selected. The display may be configured to present information such as which information has been inputted.

The controller 1171 may be configured to receive an input, specifically data, via one or more input ports. This data may be indicative of which method or mode to operate, any operational parameters such as volume of sample liquid, number of samples, location of samples, aspirating or dispensing time, aspirating or dispensing speed, pre-sample and/or post-sample airgap volume.

The controller 1171, specifically the processor of the controller, may determine, based on one or more inputs, a signal or signals to send to the one or more actuators 1161, 1162, 1163, 1164. This determination may involve a set of instructions, which may be stored in memory. The controller 1171 may output signals to one or more actuators 1161, 1162, 1163, 1164, and/or to a conversion or switching means, such as an electrical relay.

The memory may comprise a computer readable storage medium such as a hard disk drive (HDD), flash drive, solid state drive, or any other form of general-purpose data storage, upon which information and various programs are arranged. Such programs may include, for example, one or more pre-programmed modes or methods of operation of the apparatus.

The apparatus may comprise one or more communication means which may provide a communication pathway between the controller 1171 via one or more input or output ports, and the one or more actuators 1161, 1162, 1163, 1164. The communication means may comprise a wire or cable, which may physically connect the controller 1171 to one or more actuators 1161, 1162, 1163, 1164. There may be a wire or cable to each actuator from the controller 1171, for example as indicated in FIG. 8. Alternatively or in addition, the communication means may comprise wireless connection, such as a transmitter and receiver.

There may be provided a first actuator 1161. The first actuator may be configured to move the pipette tip 100 relative to the plunger 200. This may allow the pipette to aspirate and/or dispense fluid. The first actuator 1161 may be configured to move the first and/or second plates 1121, 1122 relative to the third and/or fourth plates 1123, 1124. As represented in FIG. 8, the first actuator 1161 may move the second plate 1122 relative to the third plate 1123. The first actuator 1161 may be configured to receive a signal from the controller 1171 to cause movement of the plunger 200 and/or the second plate 1121, 1122 relative to pipette tip 100 and/or the third plate 1123 at a specific time and/or at a specific speed and/or by a specific amount and/or in a specific direction.

There may be provided a second actuator 1162. The second actuator 1162 may be configured to move the pipette tip 100 and/or plunger 200 relative to a fixed housing 1101. As represented in FIG. 8, the second actuator 1162 may move the third plate 1123 relative to a housing 1101. This allows the pipette tip 100 and/or plunger 200 to be moved relative to a sample receptacle. The second actuator 1162 may be configured to receive a signal from the controller 1171 to cause movement of the pipette tip 100 and/or plunger 200 and/or the third plate 1123 relative to a sample container, at a specific time and/or at a specific speed and/or by a specific amount and/or in a specific direction.

The apparatus may comprise a body with a receptacle receiving area, such as a microplate receiving area, or deck, and a pipetting head positioned above the microplate receiving area. The microplate receiving area may have a substantially horizontal upper surface arranged to receive a laboratory microplate. The receiving area can be located on a height-adjustable support structure which enables the height of the microplate receiving area to be varied as required. The receiving area may be configured to retain a laboratory microplate in a fixed position. For example, the upper surface of the receiving area may comprise one or more recesses arranged to receive a microplate and to prevent lateral translation of the microplate with respect to the receiving area. The pipetting head of the apparatus may be configured to hold an array of pipettes, and may be moveable in relation to a deck to bring pipettes mounted on the pipetting head into close proximity to a microplate supported on the deck to allow liquid to be aspirated from or dispensed into the wells of the microplate.

The second actuator 1162 may be configured to move the second and third plates 1122 and 1123 relative to the microplate receiving area. The fixed housing 1101 may be attached to the microplate receiving area.

There may be provided a third actuator 1163. The third actuator 1163 may be configured to, upon receipt of a signal from the controller 1171, attach and/or disconnect the plunger from the system. The third actuator may be connected to the first plate and second plate 1121, 1122, so as to move the first plate 1121 relative to the second plate 1122. The third actuator 1163 may be a rotary actuator, which may be configured to provide linear movement of the first plate 1121 relative to the second plate 1122.

There may be provided a fourth actuator 1164. The fourth actuator 1164 may be configured to, upon receipt of a signal from the controller 1171, attach and/or disconnect the pipette tip 100 from the system. The fourth actuator may be connected to the third plate and the fourth plate 1123, 1124. The fourth actuator 1163 may be a rotary actuator.

To perform an aspirating operation, the plunger 200 and pipette tip 100, or series of plungers and pipette tips, may be moved to the desired position relative to a liquid sample receptacle. The plunger 200, or plunger 200 of each pipette 10 may then be raised within its respective pipette tip 100, which may be done using the first actuator 1161, which may be a direct drive actuator to move plates 1121 and 1123 relative to one another in the direction of arrows 1161′. This may move the entire plunger clamping mechanism 1140, and the plunger plates 1121, 1122 away from the pipette tip clamping mechanism 1120 and the pipette tip plates 1123, 1124, as shown in FIG. 8, to draw fluid into the pipette tip 100. The fluid can then be dispensed as desired by moving the plunger clamping mechanism 1140 in the opposite direction using the direct drive actuator 1161.

The direct drive actuator 1161 may be operable to move the plunger clamping mechanism 1140 in an axial direction towards or away from a plate or plates of the pipette tip clamping mechanism 1120 to aspirate or dispense liquid during use. There may be provided a head chassis, and the direct drive actuator 1161 may be fixed in relation to the head chassis.

The direct drive actuator 1161 may extend between the head chassis and the plunger clamping mechanism 1140. The direct drive actuator 1161 may comprise an actuator motor, which may be mounted on the top surface of a head chassis and extends between the head chassis and the plunger. The output shaft of the actuator motor 1161 may be fixed to a threaded rod connected to a ball screw actuator nut. The nut may be fixed to a ball screw mount which in turn is fixed to a plunger clamp motor mount plate at the upper end of the plunger clamping mechanism 1140. The direct drive actuator 1161 thus may extend between the head chassis and the plunger clamping mechanism 1140. When the actuator motor 1161 is operated, the entire plunger clamping mechanism 1140 may be moved in the axial direction either towards or away from the pipette tip clamping mechanism 1120, to move the plunger in one axial direction or another relative to the pipette tip 100, depending on the direction of rotation of the actuator motor 1161. In this manner, the speed of relative movement between a plunger clamped by the plunger clamping mechanism 1140 and the pipette tip within which it extends can be varied to a much greater extent than with known devices. This allows the apparatus to be used in a non-contact dispensing mode as well as a contact dispensing mode. When performing non-contact dispensing, a liquid sample must be travelling at a high enough velocity to detach from the tip. Sufficient velocity for non-contact dispensing can be achieved with the direct drive actuator 1161, which cannot be achieved with a belt drive. Specifically, direct drive via a ball screw offers higher acceleration and deceleration of heavy loads than a belt driven system. This is particularly advantageous where the distance travelled for a dispense shot is small (for example, <1 mm), therefore high acceleration and deceleration allows the system to reach target velocity. In addition, ball screws offer higher positional accuracy and repeatability, which is has a beneficial effect on dispense performance.

The apparatus may be configured such that the controller 1171, specifically the memory and processor, causes the first actuator and the second actuator 1161, 1162 to carry out aspirating/dispensing steps.

For example, the controller 1171 may comprise a computer readable medium which comprises instructions that, when executed by the processor, cause the processor to send a signal to cause retraction of the plunger 200 within the pipette tip 100 so as to aspirate air to form a pre-sample air gap 300;
output a signal to cause insertion of the pipette tip 100 into a sample liquid 351;
output a signal to cause retraction of the plunger 200 within the pipette tip 100 so as to aspirate sample liquid 351; and
output a signal to cause withdrawal of the pipette tip 100 from the sample liquid 351. The computer readable medium may comprise instructions that, when executed by a processor, cause the processor to carry out any of the method steps noted herein.

The signal to cause insertion of the pipette tip 100 into a sample liquid 351 may be sent to the second actuator 1162. The signal to cause retraction of the plunger 200 within the pipette tip 100 so as to aspirate sample liquid 351 may be sent to the first actuator 1161. The signal to cause withdrawal of the pipette tip 100 from the sample liquid 351 may be sent to the second actuator 1162.

The controller 1171 may comprise a computer readable medium, which comprises instructions that, when executed by the processor, cause the processor to send a signal to cause disconnection of the pipette tip 100 and/or plunger 200 from the apparatus. This signal may be sent to the third actuator 1163 and/or the fourth actuator 1164.

One, more or all actuators 1161, 1162, 1163, 1164 may be configured to cause movement in the same direction. When installed, one, more or all actuators 1161, 1162, 1163, 1164 may be configured to cause movement of the system in an axial direction which may be a vertical direction.

Any or each aspirating and/or dispensing method may further comprise driving the pipette tip 100 up and down as a preliminary step. This may be caused by the first actuator 1161.

As a skilled person will appreciate from the teaching herein, the liquid dispensing apparatus may be configured to allow the user to input one or more variables, and carry out one or more operating modes or methods using the same apparatus. This provides an apparatus which is versatile, and particularly suitable for various aspirating and dispensing methods.

The skilled person will appreciate that the combinations of steps described and shown in FIGS. 4 to 7 are for illustration only, and not a depiction of the only possible step combinations.

Any of the method steps listed herein may be performed in the order provided or in another suitable order. Any of the method steps listed for any embodiment herein may be performed or with any other appropriate method steps described herein.

Although the invention has been described above with reference to one or more preferred embodiments, it will be appreciated that various changes or modifications may be made without departing from the scope of the invention as defined in the appended claims.

What is claimed is:

1. A liquid handling system for dispensing liquid, comprising:
a pipette tip, having:
a proximal end and a distal end and a longitudinal axis extending therebetween;
an aperture at the distal end;
a fluid cavity extending from the aperture at least partly towards the proximal end;
an end portion disposed at the distal end, having an inner wall extending at an angle of at most 10 degrees relative to the longitudinal axis;
a plunger positioned inside the pipette tip, configured to extend between the proximal and distal ends of the pipette tip, and movable toward and away from the aperture;
wherein the system is configured to carry out at least two different operating methods for dispensing liquid.

2. The system of claim 1, wherein the at least two operating methods comprise at least two of the following:
a contact dispense method, including creating no pre-sample, nor post sample, air gap;
a non-contact dispense method, including creating no pre-sample, nor post sample, air gap;
a non-contact dispense method, including creating no pre-sample air gap, but including creating a post-sample air gap;
a contact dispense method including creating a pre-sample air gap;
a non-contact dispense method including creating a pre-sample air gap;
a non-contact dispense method including creating a pre-sample and a post sample air gap; and
a contact dispense method including creating a pre-sample air gap and a post-sample air gap.

3. The system of claim 1, wherein the at least two operating methods comprise at least one pre-sample airgap method, and at least one method with no pre-sample air gap.

4. The system of claim 1, wherein the two operating methods comprise at least one non-contact dispense method and at least one contact dispense method.

5. The system of claim 1, wherein the two operating methods comprise at least one post-sample air gap method, and at least one no post-sample air gap method.

6. The system of claim 1, wherein the system comprises an actuator configured to move the plunger relative to the pipette tip, to carry out the at least two operating methods.

7. The system of claim 1, wherein the system comprises a controller, comprising a processor, and a computer readable medium comprising instructions that, when executed by the processor, cause the processor to signal to an actuator to carry out any of the aspirating and/or dispensing method steps.

8. The system of claim 1, wherein the pipette tip end portion inner wall extending at an angle of at most 10 degrees relative to the longitudinal axis extends as such for at least 5 mm from the distal end; and/or
wherein the end portion has an outer wall extending at an angle of at most 10 degrees relative to the longitudinal axis, preferably for at least 5 mm.

9. A method of dispensing a sample liquid, comprising:
providing a liquid handling apparatus for aspirating and/or dispensing liquid, comprising:
a pipette tip, having:
a proximal end and a distal end and a longitudinal axis extending therebetween;
an aperture at the distal end,
a fluid cavity extending from the aperture at least partly towards the proximal end;
an end portion disposed at the distal end, having an inner wall extending at an angle of at most 10 degrees relative to the longitudinal axis;
a plunger positioned inside the pipette tip, configured to extend within the end portion between the proximal and distal ends of the pipette tip, and movable toward and away from the aperture;
a sealing portion configured to form a fluid-tight seal between the plunger and the pipette tip;
retracting the plunger within the pipette tip so as to aspirate air to form a pre-sample air gap;
inserting the pipette tip into a sample liquid; retracting the plunger within the pipette tip so as to aspirate sample liquid; and
withdrawing the pipette tip from the sample liquid.

10. The method of claim 9, further comprising retracting the plunger within the pipette tip so as to aspirate air to form a post-sample air gap.

11. The method of claim 9, further comprising: moving the plunger within the pipette tip so as to dispense the aspirated sample liquid such that the sample liquid detaches from the pipette tip without contacting a sample receptacle.

12. The method of claim 9, further comprising: moving the plunger within the pipette tip so as to dispense the aspirated sample liquid such that the sample liquid contacts a sample receptacle and/or or liquid, such as sample fluid, in a sample receptacle without detaching from the pipette tip.

13. The method of claim 9, further comprising driving the pipette tip up and down as a preliminary step.

14. A liquid handling apparatus for aspirating and/or dispensing liquid, comprising
a pipette tip, having:
a proximal end and a distal end and a longitudinal axis extending therebetween;
an aperture at the distal end;
a fluid cavity extending from the aperture at least partly towards the proximal end;
an end portion disposed at the distal end, having an inner wall extending at an angle of at most 10 degrees relative to the longitudinal axis;
a plunger positioned inside the pipette tip, configured to extend within the end portion between the proximal and distal ends of the pipette tip, and movable toward and away from the aperture;
a sealing portion configured to form a fluid-tight seal between the plunger and the pipette tip;
configured to carry out the steps of:
retracting the plunger within the pipette tip so as to aspirate air to form a pre-sample air gap;
inserting the pipette tip into a sample liquid;
retracting the plunger within the pipette tip so as to aspirate sample liquid; and
withdrawing the pipette tip from the sample liquid.

15. A computer program comprising instructions that, when executed by a computer processor, cause the processor to carry out the following steps:
outputting a signal to cause retraction of a plunger within a pipette tip so as to aspirate air to form a pre-sample air gap;
outputting a signal to cause insertion of the pipette tip into a sample liquid;
outputting a signal to cause retraction of the plunger within the pipette tip so as to aspirate sample liquid; and
outputting a signal to cause withdrawal of the pipette tip from the sample liquid.

16. The computer readable medium of claim 15, comprising instructions that, when executed by a processor, cause the processor to generate output signals to carry out the steps of claim 9.
